(19) United States
(12) Patent Application Publication
(10) Pub. No.: US 2025/0249800 A1
(43) Pub. Date: Aug. 7, 2025

(54) SLIDE DEVICE

(71) Applicant: DELTA KOGYO CO., LTD., Hiroshima (JP)

(72) Inventors: Yuu INASAKO, Hiroshima (JP); Toshinori HAYASHI, Hiroshima (JP); Ryo ONIKI, Hiroshima (JP)

(73) Assignee: DELTA KOGYO CO., LTD., Hiroshima (JP)

(21) Appl. No.: 18/855,107

(22) PCT Filed: Apr. 21, 2023
(86) PCT No.: PCT/JP2023/015900

§ 371 Date: Oct. 8, 2024

(30) Foreign Application Priority Data
May 27, 2022 (JP) 2022-086647

(51) Int. Cl. B60N 2/08; B60N 2/07

(52) U.S. Cl. CPC B60N 2/08; B60N 2/0722

(57) ABSTRACT

A sliding device attains a decrease in the number of components, and achieves compatibility of increasing in a pitch between balls and increasing in a movement amount of an upper rail. The sliding device includes: lower balls and a retainer arranged in a lower space between a lower rail and an upper rail; a lower coming-off prevention part at the lower rail; and an upper coming-off prevention part at the upper rail. The retainer includes: a first ball holding part; a second ball holding part; a connection part that connects the holding parts to each other therebetween; a pair of lower facing parts; and a pair of upper facing parts. The pair of lower facing parts face each other across the lower coming-off prevention part in a front-rear direction. The pair of upper facing parts face each other across the upper coming-off prevention part in the front-rear direction.

### TECHNICAL FIELD

The present invention relates to a sliding device for supporting a seat slidably and locking the seat in a desired position.

### BACKGROUND ART

A sliding device for supporting a seat slidably in a front-rear direction and locking the seat in a desired position has been conventionally and widely adopted for an automobile seat or other seat.

Such a sliding device has, for example, a structure described in Patent Literature 1. The sliding device includes: a lower rail to be fixedly attached to a floor surface of an automobile in a front-rear direction of a seat; an upper rail to be fixedly attached to the seat and guided by the lower rail movably in the front-rear direction; a plurality of balls arranged in a space between the lower rail and the upper rail and being rollable in coincidence with a movement of the upper rail; and a retainer that is arranged in the space and has ball holding parts for holding the balls at front and rear ends thereof.

To prevent the retainer that retains the balls from coming-off, the sliding device further includes a pair of lower coming-off prevention parts (or lower displacement prevention parts) at the opposite ends of the lower rail in a longitudinal direction, and a pair of upper coming-off prevention parts (or upper displacement prevention parts) at the opposite ends of the upper rail in the longitudinal direction.

The sliding device is required to include the pair of lower coming-off prevention parts at the opposite ends of the lower rail in the longitudinal direction and the pair of upper coming-off prevention parts at the opposite ends of the upper rail in the longitudinal direction to provide the structure for preventing the retainer for retaining the balls from coming off. This requirement is disadvantageous in an increase in the number of processing portions and components to prevent the retainer from coming off.

Moreover, the pair of lower coming-off prevention parts at the lower rail and the pair of upper coming-off prevention parts at the upper rail are arranged to sandwich the retainer from the opposite sides in the longitudinal direction. The arrangement is disadvantageous in limiting the length of the retainer, resulting in a failure to give a longer pitch between front and rear balls retained by the retainer.

Besides, a shorter pitch between the balls may lead to unstable support of the upper rail, thereby making the upper rail easily rattle. Here, a possible way to avoid the rattling of the upper rail may include increasing an entire length of each of the upper rail and the lower rail to increase a pitch between the ball holding parts at the front and rear ends of the retainer. However, this way tends to make the upper rail and the lower rail warp. Such warpage may make the rails rub each other or lead to complicated assembling of the upper rail. Further, the longer rails are not preferable in terms of an arrangement place for the sliding device and an increase in the weight of the sliding device.

Another possible way may include increasing the length of the retainer to increase the pitch between the balls without changing the length of each of the upper rail and the lower rail. However, this way is disadvantageous in a decrease in a movable range of the retainer in the upper rail and the lower rail, resulting in a reduction in a movement amount of the upper rail.

These ways with the aforementioned structures thus face difficulty in achieving compatibility of an increase in the pitch between the balls and an increase in the movement amount of the upper rail.

### CITATION LIST

### Patent Literature

Patent Literature 1: Korean Patent Publication No. 10-0813697

### SUMMARY OF INVENTION

The present invention has been accomplished in view of the circumstances described above, and has an object of providing a sliding device that attains a decrease in the number of processing portions and components, and that further achieves compatibility of an increase in a pitch between balls and an increase in a movement amount of an upper rail.

To solve the disadvantages described above, a sliding device in the present invention is a sliding device for supporting a seat slidably. The sliding device includes: a lower rail that is a long member to be fixedly attached to a mounting surface over which the seat is arranged; an upper rail that has a portion to be fixedly attached to the seat, is movably guided by the lower rail in a longitudinal direction of the lower rail, and defines at least one space extending in the longitudinal direction in combination with the lower rail; a plurality of balls arranged in the space between the lower rail and the upper rail and being rollable in coincidence with a movement of the upper rail; a retainer arranged in the space for retaining the balls located away from each other in the longitudinal direction; a lower coming-off prevention part provided at the lower rail for preventing the retainer from coming off the space; and an upper coming-off prevention part provided at the upper rail for preventing the retainer from coming off the space. The retainer includes: a first ball holding part that holds at least one of the balls arranged in the gap in a rollable manner; a second ball holding part that is at a distance from the first ball holding part in the longitudinal direction in the space and holds at least one of the balls in a rollable manner; a connection part that connects the first ball holding part and the second ball holding part to each other while keeping the distance between the first and second ball holding parts; a pair of lower facing parts that face each other across the lower coming-off prevention part in the longitudinal direction; and a pair of upper facing parts that face each other across the upper coming-off prevention part in the longitudinal direction.

The definition “across the lower coming-off prevention part” does not mean that the pair of lower facing parts sandwich the lower coming-off prevention part therebetween, but means that the lower coming-off prevention part is located between the lower facing parts at a distance which is longer than a length of the lower coming-off prevention part therebetween in the longitudinal direction. Similarly, the definition “across the upper coming-off prevention part” does not mean that the pair of upper facing parts sandwich the upper coming-off prevention part therebetween, but means that the upper coming-off prevention part is located between the upper facing parts at a distance which is longer than a length of the upper coming-off prevention part therebetween in the longitudinal direction.

### BRIEF DESCRIPTION OF DRAWINGS

FIG. 1 is an overall perspective view of a structure of two sliding devices attached to a lower surface of a seat, according to an embodiment of the present invention.

FIG. 2 is an overall perspective view of each of the sliding devices in FIG. 1.

FIG. 3 is a cross-sectional view taken along the line III-III in FIG. 2.

FIG. 4 is an exploded perspective view of the sliding device in FIG. 2.

FIG. 5 is a perspective view of a structure of the upper rail in FIG. 4 to which a bracket is attached, the bracket constituting a part of a lock mechanism and having an upper coming-off prevention part.

FIG. 6 is a perspective view of a retainer in FIG. 4.

FIG. 7 is an explanatory view schematically illustrating an arrangement of the retainer, four lower balls, and two upper balls in the sliding device in FIG. 2.

FIG. 8 is an enlarged view of a front area of the retainer in FIG. 7 and illustrates an arrangement of the retainer and two lower balls in a lower space and one upper ball in an upper space.

FIG. 9 is a top view of the lower rail, a pair of retainers, and the bracket constituting a part of the lock mechanism at the upper rail in FIG. 4.

FIG. 10 is an explanatory view schematically illustrating the retainer, a lower coming-off prevention part at the lower rail, and an upper coming-off prevention part at the upper rail in FIG. 9.

FIG. 11 is an illustration of a state where the upper coming-off prevention part at the upper rail in FIG. 4 moves to a rearmost end and comes into contact with a stopper at the lower rail while coming into no contact with an upper facing part of the retainer in a top view.

FIG. 12 is an illustration of a state where the upper coming-off prevention part at the upper rail in FIG. 4 moves to a foremost end and comes into contact with a stopper at the lower rail while coming into no contact with an upper facing part of the retainer in a top view.

FIG. 13A is an explanatory view schematically illustrating a state where the upper coming-off prevention part at the upper rail in FIG. 12 moves to the foremost end without coming into no contact with the upper facing part of the retainer. FIG. 13B is an explanatory view illustrating a state where the upper coming-off prevention part in FIG. 13A is in no contact with the front upper facing part of the retainer. FIG. 13C is an explanatory view illustrating a state where the lower coming-off prevention part in FIG. 13A is in no contact with the rear lower facing part of the retainer.

FIG. 14A is an explanatory view showing a maximum movement amount in the sliding device in the embodiment. FIG. 14B is an explanatory view showing a maximum movement amount in a conventional sliding device including a lower rail and an upper rail respectively having coming-off prevention parts for a retainer at front and rear ends thereof.

FIG. 15A is an explanatory view showing an increase in the movement amount of the upper rail in the sliding device in the embodiment that includes a longer retainer. FIG. 15B is an explanatory view showing a reduction in a movement amount of an upper rail in a conventional sliding device including a lower rail and the upper rail, the lower rail and the upper rail having coming-off prevention parts for a retainer respectively at front and rear ends thereof, and the retainer being longer.

FIG. 16 is an explanatory view schematically illustrating a modification of the sliding device in the present invention, the modified sliding device including a retainer that includes a pair of lower facing parts and a pair of upper facing parts, the lower facing parts being at different positions from positions of the upper facing parts in a longitudinal direction.

FIG. 17A to FIG. 17C are each an explanatory view showing a difference between a frontward movement amount and a rearward movement amount in the sliding device in FIG. 16.

### DESCRIPTION OF EMBODIMENTS

Hereinafter, a preferable embodiment of a sliding device in the present invention will be described with reference to the accompanying drawings.

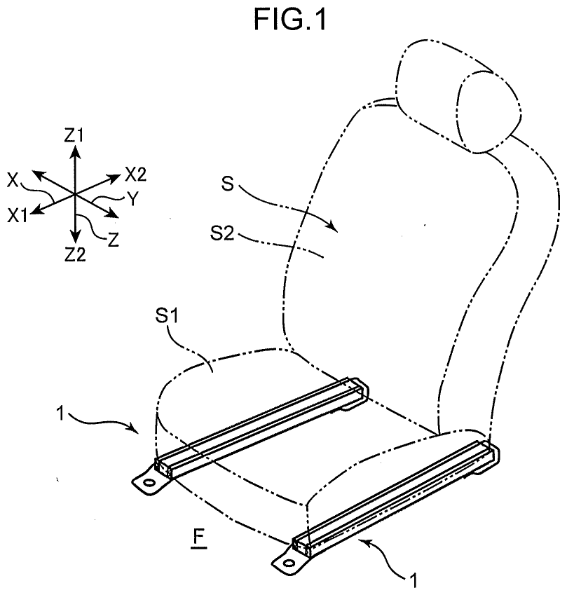

A sliding device 1 according to the embodiment is, for example, a device for supporting a seat S adoptable as an automobile seat slidably in a front-rear direction X as illustrated in FIG. 1. The seat S includes a seat cushion S1 and a seatback S2 standing upward from a rear portion of the seat cushion S1. A pair of the sliding devices 1 extend in the front-rear direction X, are apart from each other in a width direction Y, and are located between a lower surface of the seat cushion S1 and a floor surface F of the automobile. The sliding devices 1 in the present invention may be arranged in a left-right direction (or width direction) for allowing the seat S to move in the left-right direction without limitation to the arrangement in the front-rear direction of the seat S.

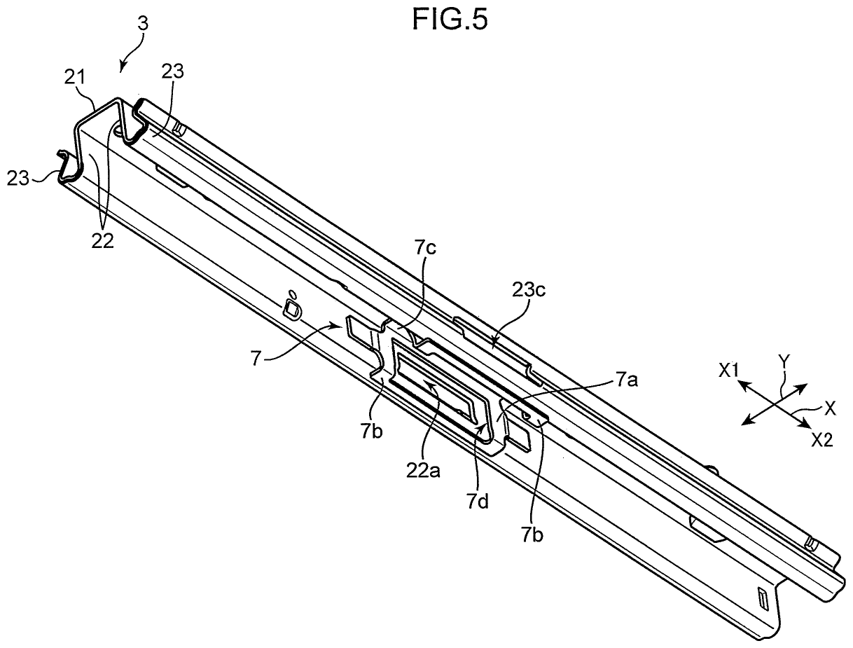

A illustrated in FIG. 1 to FIG. 4, each sliding device 1 includes: a lower rail 2 configured to support the seat S slidably and extending in a front-rear direction X; an upper rail 3 slidably assembled to the lower rail 2; a plurality of lower balls 4 and a plurality of upper balls 5 that slidably support the upper rail 3; a retainer 6 that retains the lower balls 4 in a rollable manner; a lower coming-off prevention part 8 for preventing the retainer from coming off; an upper bracket 7 including an upper coming-off prevention part 7b (see FIG. 5) for preventing the retainer from coming off; and a pair of stoppers 9, 10 that limit a movement range of each of the upper bracket 7 and the upper rail 3. In the embodiment, a longitudinal direction of the lower rail 2 agrees with the front-rear direction X.

In the embodiment, the retainer 6 retains four lower balls 4 in total, that is, two lower balls at a front end and two lower balls at a rear end thereof. Each upper ball 5 is arranged in a region corresponding to a region between the two lower balls 4 at each of the front and rear opposite ends of the retainer 6 in the front-rear direction X without being retained by a retainer. It is noted that at least one lower ball 4 is to be retained at each of the front and rear ends of the retainer 6.

The lower rail 2 is a long member extending in the front-rear direction X to be fixedly attached to the floor surface F of the automobile. Specifically, the lower rail 2 includes a bottom wall 11 that is a flat plate extending in the front-rear direction X to be fixedly attached to the floor surface, a pair of outer walls 12 standing upward Z1 from the opposite edges of the bottom wall 11, a pair of upper walls 13 extending from respective upper edges of the pair of outer walls 12 toward the center in the width direction Y of the lower rail 2, and a pair of inner walls 14 extending downward Z2 from respective ends of the pair of upper walls 13 that are closer to the center in the width direction Y. The bottom wall 11, the pair of outer walls 12, the pair of upper walls 13, and the pair of inner walls 14 define a pair of space sections 15 each extending in the front-rear direction X.

The upper rail 3 has a portion to be fixedly attached to the seat S, is movably guided by the lower rail 2 in the front-rear direction X, and is configured to define at least one space, that is, a pair of lower spaces 41 and a pair of upper spaces 42 in the embodiment, extending in the front-rear direction X in combination with the lower rail 2.

Specifically, the upper rail 3 includes a top wall 21 that is a flat plate extending in the front-rear direction X to be fixedly attached to the seat S, a pair of side walls 22 extending downward Z2 from the opposite edges of the top wall 21, and a pair of bent parts 23 bent outward in the width direction Y of the upper rail 3 from respective lower edges of the pair of side walls 22. The pair of bent parts 23 are respectively disposed in the pair of space sections 15 of the lower rail 2.

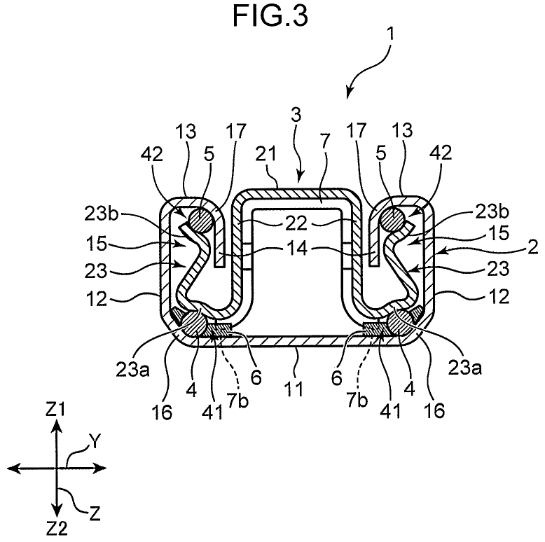

As illustrated in FIG. 3, each of the pair of bent parts 23 has a lower portion 23a having an outer surface curving upward Z1 in a U-shape to come into contact with the corresponding lower ball 4, and an upper portion 23b having an upper surface curving inward in an L-shape in the width direction as advancing upward from the lower portion 23a and then curving outward in the width direction to come into contact with the corresponding upper ball 5. Each lower space 41 is defined between: the lower portion 23a of the bent part 23; and a connection portion 16 of the bottom wall 11 and the outer wall 12, at each of the opposite ends of the upper rail 3 in the width direction. Each upper space 42 is defined between: the upper portion 23b of the bent part 23; and a connection portion 17 of the inner wall 14 and the upper wall 13, at each of the opposite ends of the upper rail 3 in the width direction.

The lower balls 4 are arranged in the pair of lower spaces 41 respectively between the lower rail 2 and the upper rail 3 and are rollable in coincidence with a movement of the upper rail 3. Similarly, the upper balls 5 are arranged in the pair of upper spaces 42 respectively between the lower rail 2 and the upper rail 3 and are rollable in coincidence with the movement of the upper rail 3.

In the embodiment, the retainer 6 is a member arranged in each of the pair of lower spaces 41 for retaining the lower balls 4 located away from each other in the front-rear direction X. The configuration of the retainer 6 will be described in detail later.

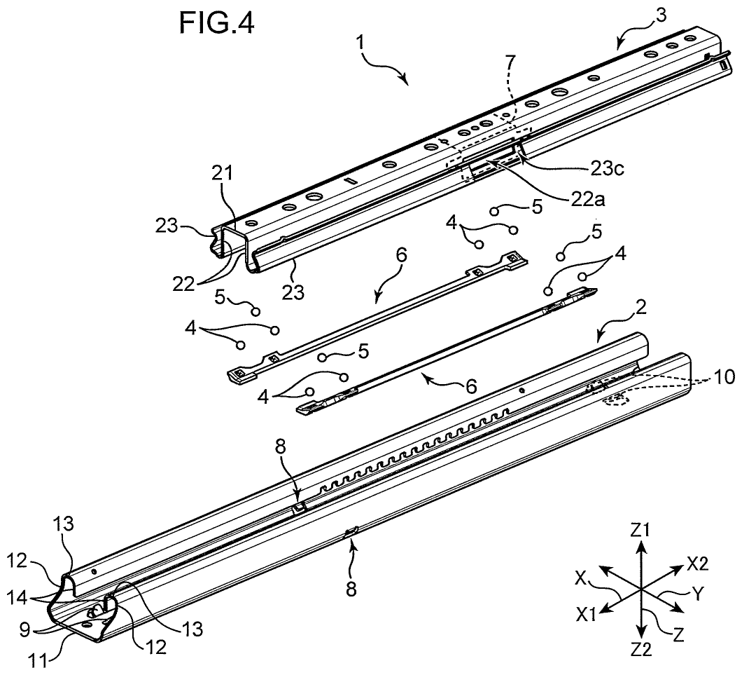

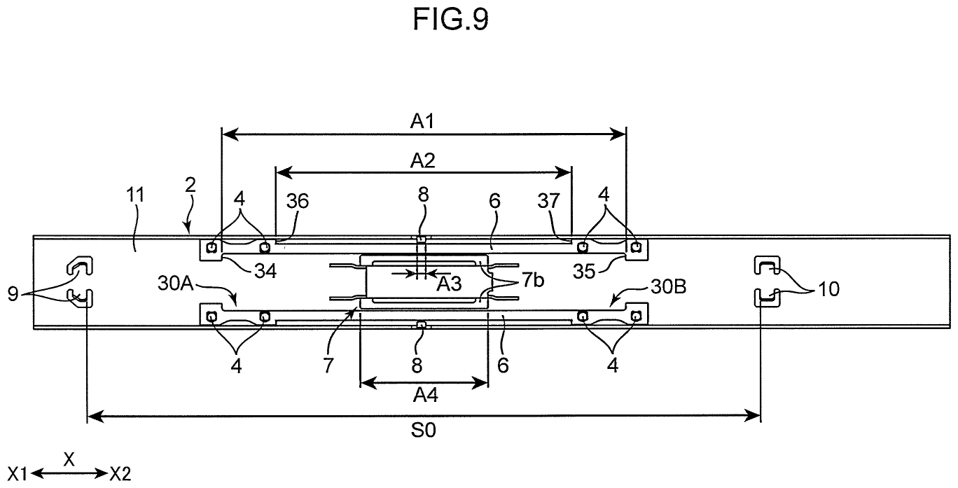

As illustrated in FIG. 4 and FIG. 9, the lower coming-off prevention part 8 is provided at the lower rail 2 for preventing the retainer 6 from coming off the lower space 41. In the embodiment, the lower coming-off prevention part 8 is at a middle position of each of the opposite outer walls 12 of the lower rail 2 in the front-rear direction X. Specifically, the lower coming-off prevention part 8 is formed by lancing a portion around a lower end of the outer wall 12 inward in the width direction of the lower rail 2.

As illustrated in FIG. 5, the upper coming-off prevention part 7b is provided at the upper rail 3 for preventing the retainer 6 from coming off the lower space 41. In the embodiment, the upper coming-off prevention part 7b constitutes a part of the upper bracket 7 illustrated in FIG. 3 to FIG. 5 and FIG. 9.

The upper bracket 7 holds a lock mechanism (not shown) configured to fix the upper rail 3 in a desired position in the front-rear direction X, and is at a middle position in the inside of the upper rail 3 in the front-rear direction X as illustrated in FIG. 3 to FIG. 4.

Specifically, as illustrated in FIG. 5, the upper bracket 7 has a pair of side walls 7a being in contact with inner surfaces of the pair of side walls 22 of the upper rail 3 respectively, a pair of upper coming-off prevention parts 7b each having a flange shape extending outward in the width direction Y of the upper rail 3 from a lower end of the associated side wall 7a, and a top wall 7c being in contact with a lower surface of the top wall 21 of the upper rail 3.

Each side wall 7a has an opening 7d having a rectangular shape. The opening 7d communicates with an opening 22a in the associated side wall 22 of the upper rail 3 and an opening 23c in the associated bent part 23 to allow a constituent component (such as a lock plate) of the lock mechanism (not shown) to be inserted therethrough.

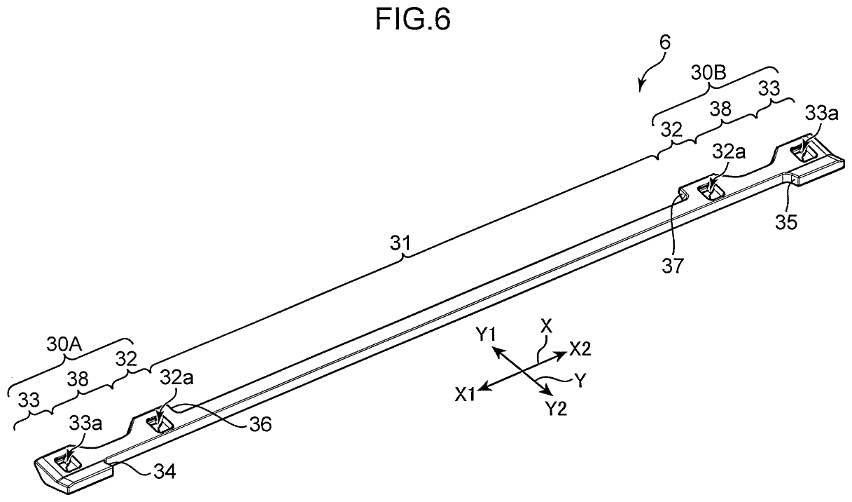

As illustrated in FIG. 6 to FIG. 8, the retainer 6 includes: a first ball holding part 30A; a second ball holding part 30B; a connection part 31; a pair of lower facing parts 36, 37; and a pair of upper facing parts 34, 35. The retainer 6 is integrally made of synthetic resin, metal material, or other material. The first ball holding part 30A and the second ball holding part 30B have the same configuration. Hence, hereinafter, the configuration of the first ball holding part 30A will be representatively described in detail.

The first ball holding part 30A is configured to hold at least one of the lower balls 4 arranged in the lower space 41 in a rollable manner. Specifically, the first ball holding part 30A has an inner holding section 32 that is closer to the connection part 31, an outer holding section 33 that is away from the connection part 31, and a connection section 38 that connects the inner holding section 32 and the outer holding section 33 to each other. The inner holding section 32 has a holding hole 32a and the outer holding section 33 has a holding hole 33a to each hold the corresponding lower ball 4 in a rollable manner. Each of the holding holes 32a, 33a is a through hole for holding the lower ball 4 in a state where a part of the ball is exposed above and below.

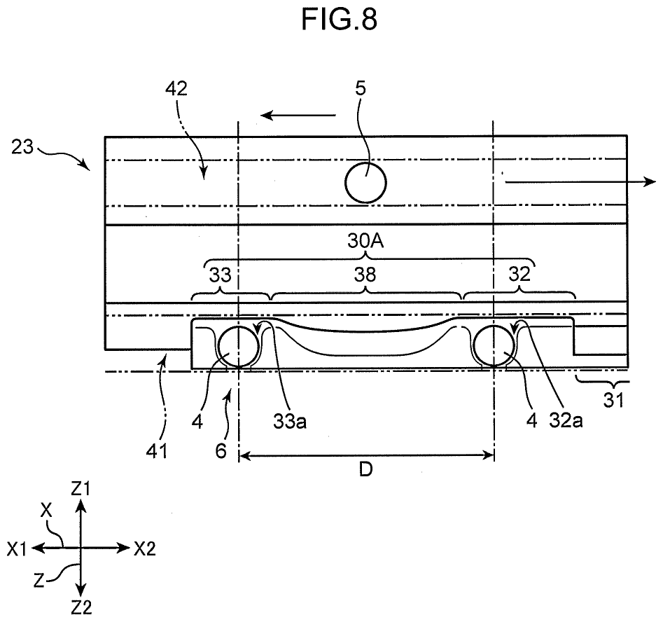

The connection section 38 connects the inner holding section 32 and the outer holding section 33 to each other to keep a distance between the center of the lower ball 4 held by the inner holding section 32 and the center of the lower ball 4 held by the outer holding section 33 at a predetermined distance D (see FIG. 8).

As illustrated in FIG. 8, in the embodiment, the predetermined distance D permits the upper ball 5 arranged in the upper space 42 in which no retainer 6 is arranged to travel in the front-rear direction X.

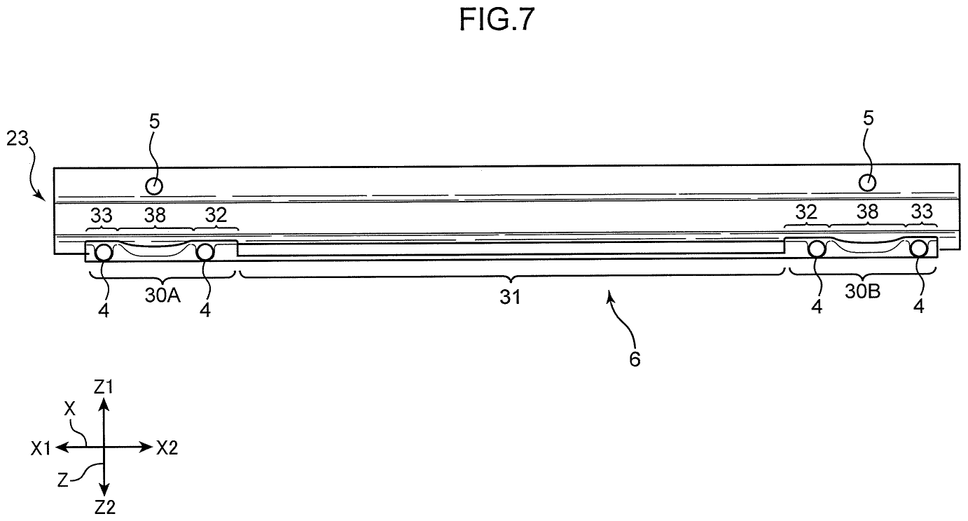

As illustrated in FIG. 7 to FIG. 8, in the embodiment, at least one upper ball 5 is arranged, in the upper space 42, in a region corresponding to the predetermined distance D between the two lower balls 4 in the front-rear direction X. The upper ball 5 is rollable in the region corresponding to the distance D, and cannot go out of the region at a position corresponding to the location of each lower ball 4 where the upper space 42 is slightly narrower due to a flexure or other influence of the upper rail 3.

The sliding device 1 in the embodiment has such a simple configuration that the upper ball 5 is arranged in the region corresponding to the predetermined distance D between the two lower balls 4 without a retainer for retaining the upper ball 5 in a rollable manner.

The second ball holding part 30B is at a distance from the first ball holding part 30A in the front-rear direction X in the lower space 41 and holds at least one of the lower balls 4 in a rollable manner. Specifically, the second ball holding part 30B is configured to have an inner holding section 32, an outer holding section 33, and a connection section 38 in the same manner as the first ball holding part 30A.

As illustrated in FIG. 6, the connection part 31 has a rod shape and connects the first ball holding part 30A and the second holding part 30B to each other while keeping the distance between the first and second ball holding parts, specifically, the connection part 31 is a rod-shaped part having a rectangular cross-section in the embodiment.

The connection part 31 has a cross-sectional area which is smaller than a cross-sectional area of each of the first ball holding part 30A and the second ball holding part 30B in cross-section perpendicularly intersecting the front-rear direction X. Specifically, the connection part 31 in the embodiment has a rectangular cross-section which is smaller than a cross-section of each of the first ball holding part 30A and the second ball holding part 30B.

As illustrated in FIG. 6 and FIG. 9, the pair of lower facing parts 36, 37 are respectively provided at the first ball holding part 30A and the second ball holding part 30B in combination to be apart from each other and face each other. In other words, as illustrated in FIG. 9, the pair of lower facing parts 36, 37 face each other across the lower coming-off prevention part 8 in the front-rear direction X. Here, the definition “across the lower coming-off prevention part 8” does not mean that the pair of lower facing parts 36, 37 sandwich the lower coming-off prevention part 8 therebetween, but means that the lower coming-off prevention part 8 is located between the lower facing parts 36, 37 at a distance A2 which is longer than a length A3 of the lower coming-off prevention part 8 therebetween in the longitudinal direction. The pair of lower facing parts 36, 37 may be located at the connection part 31.

In the embodiment, the pair of lower facing parts 36, 37 are at opposite positions of the connection part 31 to face each other in the front-rear direction X. Specifically, the lower facing part 36 located frontward X1 is at a rear end of the first ball holding part 30A, and the lower facing part 37 located rearward X2 is at a front end of the second ball holding part 30B. The pair of lower facing parts 36, 37 protrude outward Y1 in the width direction of the sliding device 1 (i.e., protrude outward in the width direction of the lower rail 2) from a side surface of the connection part 31.

The pair of upper facing parts 34, 35 are respectively located at the first ball holding part 30A and the second ball holding part 30B in combination to be apart from each other and face each other. In other words, as illustrated in FIG. 9, the pair of upper facing parts 34, 35 face each other across the upper coming-off prevention part 7b in the front-rear direction X. Here, the definition “across the upper coming-off prevention part 7b” does not mean that the pair of upper facing parts 34, 35 sandwich the upper coming-off prevention part 7b therebetween, but means that the upper coming-off prevention part 7b is located between the upper facing parts 34, 35 at a distance A1 which is longer than a length A4 of the upper coming-off prevention part 7b therebetween in the longitudinal direction. The pair of upper facing parts 34, 35 may be located at the connection part 31.

In the embodiment, the pair of upper facing parts 34, 35 are located at opposite positions of the connection part 31 to face each other in the front-rear direction X. Specifically, the upper facing part 34 located frontward X1 in the front-rear direction X protrudes inward Y2 in the width direction (i.e., protrudes inward in the width direction of the lower rail 2) from the outer holding section 33 of the first ball holding part 30A. The upper facing part 35 located rearward X2 protrudes inward Y2 in the width direction (i.e., protrudes inward in the width direction of the lower rail 2) from the outer holding section 33 of the second ball holding part 30B.

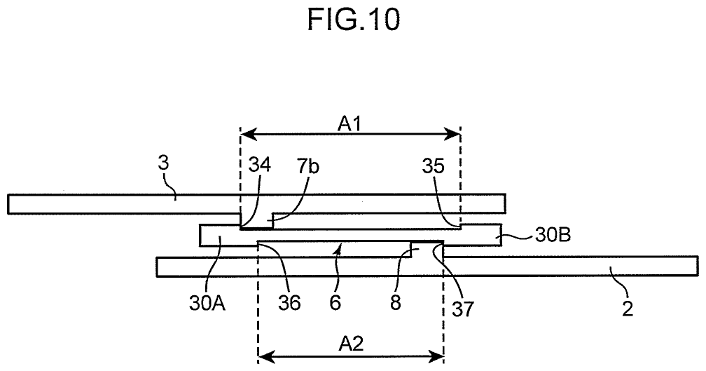

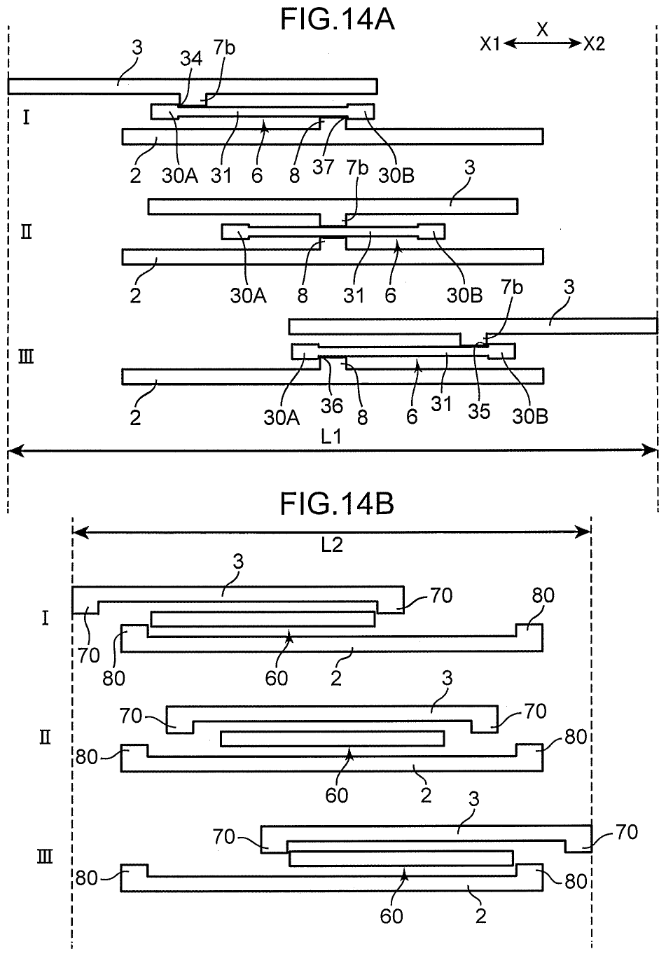

As illustrated in FIG. 9 to FIG. 10, in the sliding device 1 in the embodiment, the lower coming-off prevention part 8 falls within a region between the pair of lower facing parts 36, 37. The upper coming-off prevention part 7b falls within a region between the pair of upper facing parts 34, 35. This configuration allows each of the lower coming-off prevention part 8 and the upper coming-off prevention part 7b to fall within an extent or length of the retainer 6 in the front-rear direction X and limit a movement range of the retainer 6 to an overlapping extent of the lower rail 2 and the upper rail 3. As a result, the configuration enables prevention of coming-off of the retainer 6. Specifically, when the upper rail 3 reaches a foremost position in the state I in FIG. 14A, the upper coming-off prevention part 7b approaches the front upper facing part 34 and the lower coming-off prevention part 8 approaches the rear lower facing part 37. When the upper rail 3 reaches a rearmost position in the state III in FIG. 14A, the upper coming-off prevention part 7b approaches the rear upper facing part 35 and the lower coming-off prevention part 8 approaches the front lower facing part 36. This configuration prevents the retainer 6 from coming off regardless of frontward or rearward movement of the upper rail 3.

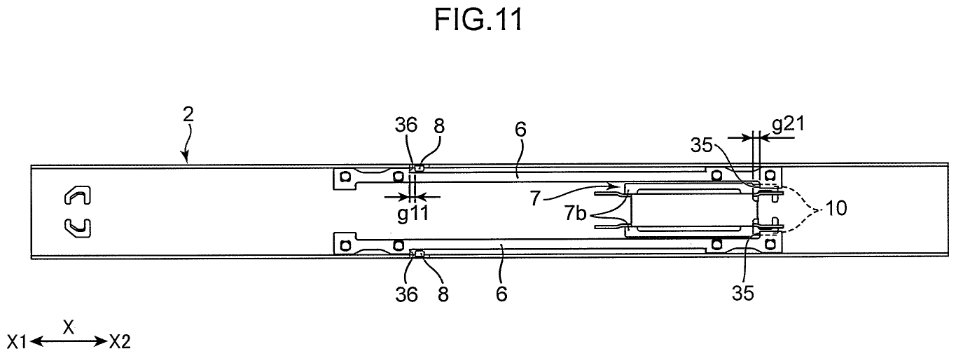

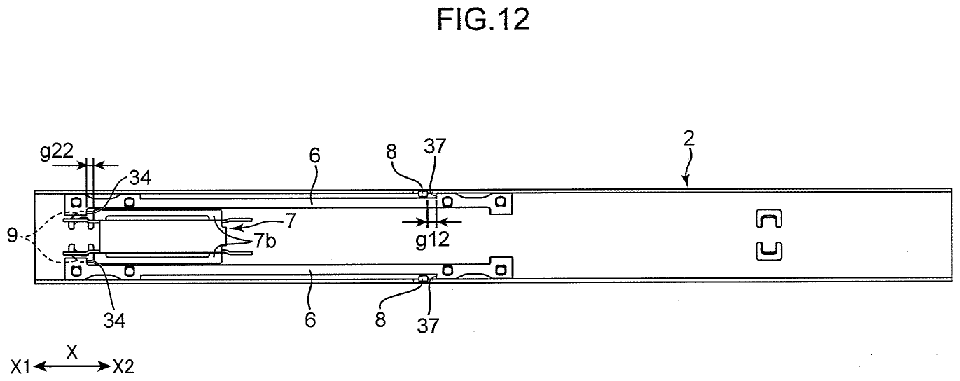

As illustrated in FIG. 4, FIG. 9, and FIG. 11 to FIG. 12, the pair of stoppers 9, 10 are located away from each other at the lower rail 2 in the front-rear direction X. In the embodiment, each of the pair of stoppers 9, 10 is formed by lancing a part of the bottom wall 11 of the lower rail 2, but may be an independent protrusion. The pair of stoppers 9, 10 are at positions (intermediate positions in the width direction) respectively at front and rear ends of the lower rail 2 where the stoppers can come into contact with the upper coming-off prevention part 7b, and the stoppers 9, 10 can limit the movement range of the upper rail 3 in the front-rear direction X by coming into contact with the upper coming-off prevention part 7b.

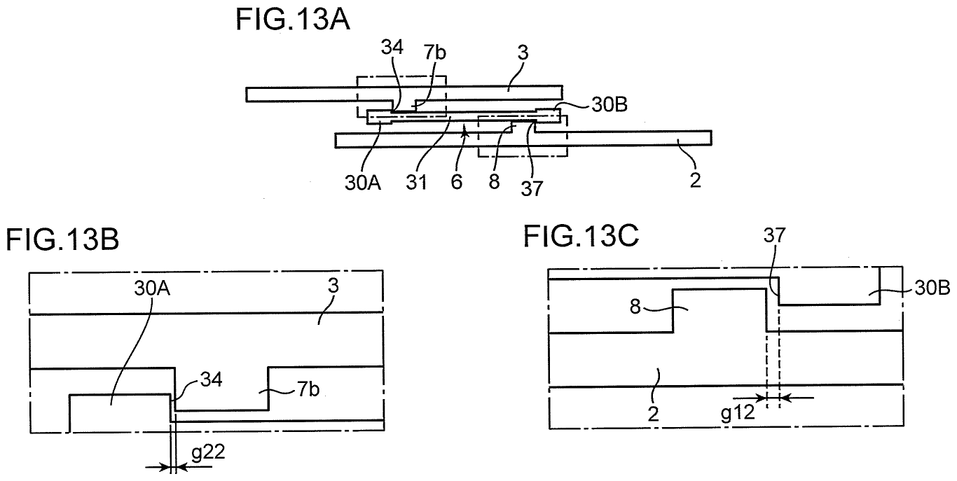

As illustrated in FIG. 11 to FIG. 13, in the embodiment, the pair of lower facing parts 36, 37 and the pair of upper facing parts 34, 35 in the retainer 6 are arranged in such a manner as to: restrict the movement of the upper rail 3 in the front-rear direction X through contact of the upper coming-off prevention part 7b with the stopper 9 or 10; and further allow a gap g11 or g12 to come into existence between the lower facing part 36 or 37 and the lower coming-off prevention part 8 without no contact therebetween in a state where the upper coming-off prevention part 7b is at a position (where a gap g21 or g22 is allowed to come into existence) adjacent to the upper facing part 34 or 35. Specifically, as illustrated in FIG. 11, in such arrangement of the pair of lower facing parts 36, 37 and the pair of upper facing parts 34, 35, the upper rail 3 and the upper bracket 7 move rearward X2, the upper coming-off prevention part 7b comes into contact with the stopper 10 located rearward X2, and the gap g11 comes into existence between the lower facing part 36 located frontward X1 and the lower coming-off prevention part 8 without no contact therebetween in a state where the upper coming-off prevention part 7b is at a position (where the gap g21 is allowed to come into existence) adjacent to the upper facing part 35. In contrast, as illustrated in FIG. 12 to FIG. 13, the upper rail 3 and the upper bracket 7 move frontward X1, the upper coming-off prevention part 7b comes into contact with the stopper 9 located frontward X1, and the gap g12 comes into existence between the lower facing part 37 located rearward X2 and the lower coming-off prevention part 8 without contact therebetween in a state where the upper coming-off prevention part 7b is at a position (where the gap g22 is allowed to come into existence) adjacent to the upper facing part 34.

To ensure a maximum movement amount (or maximum stroke amount) of the upper rail 3 in the embodiment, the length of the connection part 31 illustrated in FIG. 6 is set to such a length as to allow each of a value of two times of a length resulting from subtracting the length A3 of the lower coming-off prevention part 8 in the longitudinal direction from the distance A2 between the pair of lower facing parts 36, 37 illustrated in FIG. 9 (i.e., 2×(A2−A3)), and a value of two times of a length resulting from subtracting the length A4 of the upper coming-off prevention part 7b in the longitudinal direction from the distance A1 between the upper facing parts 34, 35 (i.e., 2×(A1−A4) to correspond to a maximum movement amount S0 of the upper rail 3 or greater. This setting of the length of the connection part 31 ensures the maximum movement amount of the upper rail 3 without a limitation attributed to the length of the connection part 31, and allows a gap to come into existence between each of the pair of upper facing parts 34, 35 and the upper coming-off prevention part 7b without contact therebetween and allows a gap to come into existence between each of the pair of lower facing parts 36, 37 and the lower coming-off prevention part 8 without contact therebetween in restriction of the movement of the upper rail 3 in the longitudinal direction by each of the stoppers 9, 10.

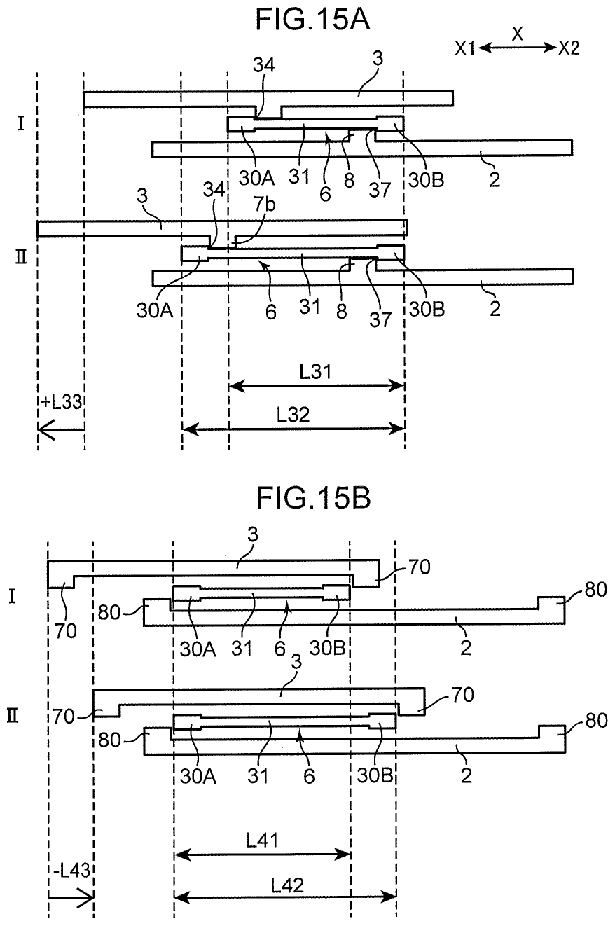

As illustrated in FIG. 9 to FIG. 10, in the embodiment, the distance A2 between the pair of lower facing parts 36, 37 differs from the distance A1 between the pair of upper facing parts 34, 35. That is to say, the pair of lower facing parts 36, 37 are at different positions from the positions of the pair of upper facing parts 34, 35 in the front-rear direction X. In this respect, even a configuration in which the upper coming-off prevention part 7b or the lower coming-off prevention part 8 has a different length in the longitudinal direction can exert the same operational effects as the configuration in which the lower and upper facing parts are at the same front and rear positions by adjusting the distance between the facing parts 34, 35 or the distance between the facing parts 36, 37. In view of a basic configuration of the sliding device 1 in the embodiment, the pair of lower facing parts 36, 37 and the pair of upper facing parts 34, 35 may be arranged at the same positions in the front-rear direction X like the configuration illustrated in FIG. 13, FIG. 14A, and FIG. 15A.

### CHARACTERISTICS OF THE EMBODIMENT

(1) In the sliding device 1 in the embodiment, as illustrated in FIG. 6 and FIG. 9, the retainer 6 including the first ball holding part 30A and the second ball holding part 30B connected to each other by the connection part 31 further includes two kind pairs of facing parts, that is, the pair of lower facing parts 36, 37 and the pair of upper facing parts 34, 35, to be apart from each other and face each other in the front-rear direction X (i.e., in the longitudinal direction of the lower rail 2). The pair of lower facing parts 36, 37 face each other across the lower coming-off prevention part 8 in the front-rear direction X. The pair of upper facing parts 34, 35 face each other across the upper coming-off prevention part 7b in the front-rear direction X. In this configuration, the lower coming-off prevention part 8 provided at the lower rail 2 falls within the region between the pair of lower facing parts 36, 37, and the upper coming-off prevention part 7b provided at the upper rail 3 falls within the region between the pair of upper facing parts 34, 35.

The configuration thus allows the lower coming-off prevention part 8 and the upper coming-off prevention part 7b each falling within the extent of the retainer 6 in the front-rear direction X to respectively come into contact with the lower facing parts 36, 37 and the upper facing parts 34, 35, resulting in achievement in preventing the retainer 6 from coming off. This eliminates the need for a coming-off prevention member for the retainer 6 at each of the front and rear ends of each of the lower rail 2 and the upper rail 3 in the front-rear direction X. Consequently, the configuration enables to suppress an increase in the number of processing portions and components to prevent the retainer 6 from coming off.

In particular, the sliding device 1 in the embodiment in which the lower coming-off prevention part 8 is formed by lancing the outer wall 12 of the lower rail 2, and the upper coming-off prevention part 7b constitutes a part of the upper bracket 7 for holding the lock mechanism attains suppression of an increase in the number of components. Specifically, as illustrated in FIG. 14B, in a conventional sliding device, special coming-off prevention parts 70 are required to be attached to front and rear ends of a lower rail 2 respectively and special coming-off prevention parts 80 are required to be attached to front and rear ends of an upper rail 3 respectively to prevent a retainer 60 from coming off after assembling of the retainer 60. The conventional sliding device has a disadvantage that the number of work steps increases as well as the number of components. In contrast, the sliding device in the embodiment is free from such a disadvantage.

As illustrated in FIG. 14A, the sliding device 1 in the embodiment including the lower coming-off prevention part 8 and the upper coming-off prevention part 7b each falling within the extent of the retainer 6 in the front-rear direction X can ensure a larger maximum movement amount (or maximum stroke amount) L1 of the upper rail 3 without a limitation attributed to a total length of the retainer 6. In contrast, as illustrated in FIG. 14B, the conventional sliding device including the coming-off prevention parts 70 at the front and rear ends of the lower rail 2 and the coming-off prevention parts 80 at the front and rear ends of the upper rail 3 for the retainer 60 fails to ensure a sufficient maximum movement amount (or maximum stroke amount) L2 of the upper rail 3 under the limitation attributed to a total length of the retainer 60 (i.e., L2<L1).

In the sliding device 1 in the embodiment, the lower coming-off prevention part 8 and the upper coming-off prevention part 7b fall within the extent of the retainer 6 in the front-rear direction X. Thus, the lower coming-off prevention part 8 and the upper coming-off prevention part 7b do not limit the distance between the first ball holding part 30A and the second ball holding part 30B of the retainer 6, that is, do not limit a pitch between balls. Hence, this embodiment enables to increase the pitch between the balls by increasing the distance between the lower facing parts 36, 37 or the distance between the upper facing parts 34, 35 in the retainer 6.

Here, a shorter pitch between the balls may lead to unstable support, and thus rattling is likely to occur. However, in the sliding device 1 in the embodiment, increasing the length of the connection part 31 as illustrated in FIG. 15A is satisfactory to achieve an increase in the pitch between the balls and avoid the rattling without the need for increasing the length of each of the lower rail 2 and the upper rail 3. This consequently prevents the lower rail 2 and the upper rail 3 from warping, and thus avoids rubbing between the rails and complicated assembling of the rails.

In the configuration, the lower coming-off prevention part 8 and the upper coming-off prevention part 7b fall within the extent of the retainer 6 in the front-rear direction X. Hence, as illustrated in FIG. 15A, increasing the distance between the lower facing parts 36, 37 or the distance between the upper facing parts 34, 35 in the retainer 6, specifically, increasing the length of the connection part 31 (more specifically, increasing the length of the connection part 31 from L31 in the state I to L32 in the state II) leads to an increase in the movement amount of the retainer 6 and an increase in the movement amount of the upper rail 3 relative to the retainer 6. As a result, the movement amount of the upper rail is remarkably increasable (specifically, the movement amount of the upper rail 3 is increased by L33).

As illustrated in FIG. 15B, in a conventional sliding device including a retainer 6 that includes a longer connection part 31 (specifically, a connection part 31 having a length increased from L41 in the state I to L42 in the state II), a movable range of the retainer 6 between a pair of lower coming-off prevention parts 80 and between a pair of upper coming-off prevention parts 70 decreases. Accordingly, the movement amount of each of the retainer 6 and the upper rail 3 also reduces. As a result, a movement amount of the upper rail 3 notably reduces (i.e., the movement amount reduces by L43).

In the embodiment, the maximum movement amount (or maximum stroke amount) of the upper rail 3 is increasable up to almost the total length of the lower rail 2. Hence, it is unnecessary to increase the length of each of the lower rail 2 and the upper rail 3 to increase the maximum movement amount. This avoids a limitation to an attachment place for the sliding device 1 or an increase in the weight of the sliding device 1.

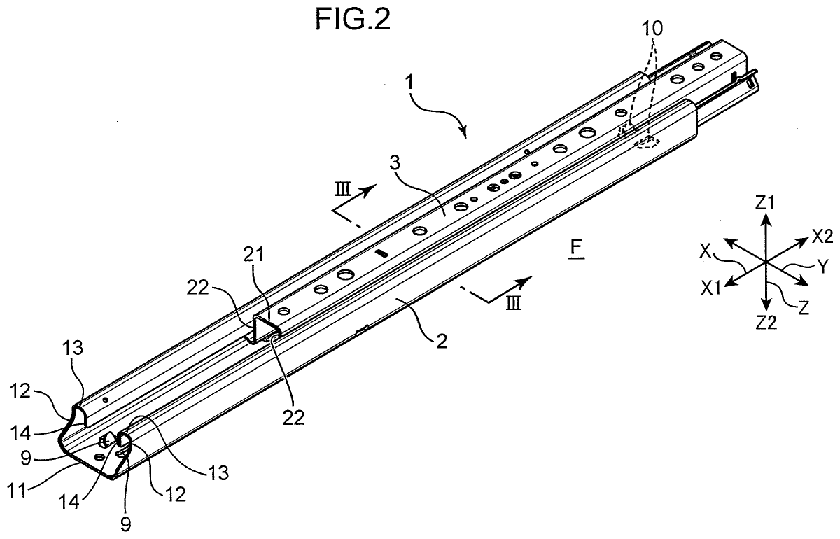

As described above, the sliding device 1 in the embodiment attains a decrease in the number of processing portions and components, and further achieves compatibility of an increase in the pitch between the lower balls 4 and an increase in the movement amount of the upper rail 3.
(2) In the sliding device 1 in the embodiment, the pair of lower facing parts 36, 37 are at opposite positions of the connection part 31 to face each other in the front-rear direction X as illustrated in FIG. 6. Besides, the pair of upper facing parts 34, 35 are provided at opposite positions of the connection part 31 to face each other in the front-rear direction X. In this configuration, the retainer 6 is movable within a range in which the pair of lower facing parts do not come into contact with the lower coming-off prevention part, that is, within an inner range between the pair of lower facing parts 36, 37. Further, as illustrated in FIG. 9 to FIG. 10, the upper rail 3 is movable within a range in which the upper coming-off prevention part 7b does not come into contact with the pair of upper facing parts 34, 35, that is, within an inner range between the pair of upper facing parts 34, 35 relative to the retainer 6. Consequently, the movement amount of the upper rail 3 is remarkably increasable.
(3) As illustrated in FIG. 2, FIG. 4, and FIG. 9, the sliding device 1 in the embodiment includes the pair of stoppers 9, 10 located away from each other in the front-rear direction X at the lower rail 2 for limiting a movement range of the upper rail 3 in the front-rear direction X by coming into contact with the upper coming-off prevention part 7b.

As illustrated in FIG. 11 to FIG. 13, the pair of lower facing parts 36, 37 and the pair of upper facing parts 34, 35 in the retainer 6 are arranged in such a manner as to allow a gap to come into existence between the lower facing part 36 (or 37) and the lower coming-off prevention part 8 without contact therebetween in a state where the upper coming-off prevention part 7b is at a position adjacent to both the stopper 9 (or 10) and the upper facing part 34 (or 35).

In this configuration, the upper coming-off prevention part 7b at the upper rail 3 comes into contact with the stopper 9 (or 10) at the lower rail 2 to restrict the movement of the upper rail 3 in the front-rear direction X. Besides, when the upper coming-off prevention part 7b reaches a position adjacent to the upper facing part 34 (or 35) of the retainer 6, the lower facing part 36 (or 37) of the retainer 6 does not come into contact with the lower coming-off prevention part 8. Even in rapid sliding of the upper rail 3, this suppresses of deformation of the retainer 6 without influence of a large pulling load acting to pull the opposite ends of the retainer 6 located in the front-rear direction X by the upper coming-off prevention part 7b and the lower coming-off prevention part 8 in different directions.

This configuration further eliminates the need for a reinforcement part to make the retainer 6 have a strength, and increases the degree of freedom for a cross-sectional shape of the retainer 6.
(4) In the sliding device 1 in the embodiment, the connection part 31 has a cross-sectional area which is smaller than a cross-sectional area of each of the first ball holding part 30A and the second ball holding part 30B in cross-section perpendicularly intersecting the front-rear direction X. This configuration achieves a reduction in each of the size, the weight, and the manufacturing cost of the retainer 6.

In the embodiment, the pair of lower facing parts 36, 37 and the pair of upper facing parts 34, 35 in the retainer 6 are arranged in such a manner as to allow a gap to come into existence between the lower facing part 36 (or 37) and the lower coming-off prevention part 8 without contact therebetween in a state where the upper coming-off prevention part 7b is in contact with the stopper 9 (or 10) and is at a position adjacent to the upper facing part 34 (or 35). That is to say, the lower coming-off prevention part 8 and the upper coming-off prevention part 7b do not come into contact with the retainer 6 at the same time. This prevents the retainer 6 from receiving a strong pulling load, and thus, attains a further smaller cross-sectional area of the connection part 31 and achieves a further reduction in each of the size and the weight of the retainer 6.
(5) In the sliding device 1 in the embodiment, the length of the connection part 31 illustrated in FIG. 6 is set to such a length as to allow each of a value of two times of a length resulting from subtracting the length A3 of the lower coming-off prevention part 8 in the longitudinal direction from the distance A1 between the pair of lower facing parts 36, 37 illustrated in FIG. 9, and a value of two times of a length resulting from subtracting the length A4 of the upper coming-off prevention part 7b in the longitudinal direction from the distance A2 between the upper facing parts 34, 35 to correspond to a maximum movement amount S0 of the upper rail 3 or greater. Such setting avoids a limitation to the movement amount of the upper rail 3 attributed to the length of the connection part 31, resulting in achieving an ensured maximum movement amount of the upper rail 3.
(6) In the sliding device 1 in the embodiment, the upper coming-off prevention part 7b constitutes a part of the upper bracket 7 that holds the lock mechanism configured to fix the upper rail 3 at a desired position in the front-rear direction X. This configuration prevents the retainer 6 from coming off by using a part of the upper bracket 7 that holds the lock mechanism configured to fix the upper rail 3. Thus, the configuration enables the prevention of coming-off of the retainer 6 without increasing the number of components of the sliding device 1.

The upper coming-off prevention part is not limited to such an upper bracket, and may be composed of any component or structure intended not only for prevention of coming-off of a retainer but also for other purpose as long as the component is located between a pair of upper facing parts.

### MODIFICATIONS

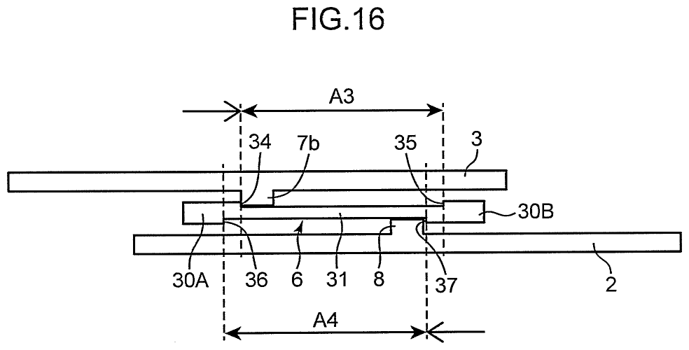

(A) The present invention does not particularly limit a relative positional relation between the pair of lower facing parts and the pair of upper facing parts. In a modification of the present invention as illustrated in FIG. 16, a pair of lower facing parts 36, 37 may be at different positions from positions of a pair of upper facing parts 34, 35 in a front-rear direction X, in other words, may be displaced in the front-rear direction X. In the modification illustrated in FIG. 16, the pair of upper facing parts 34, 35 are displaced rearward (rightward in FIG. 16) from the pair of lower facing parts 36, 37. Specifically, the front upper facing part 34 is located rearward from the lower facing part 36, and the rear upper facing part 35 is located rearward from the lower facing part 37. Further, a distance A3 between the pair of upper facing parts 34, 35 may differ from a distance A4 between the pair of lower facing parts 36, 37.

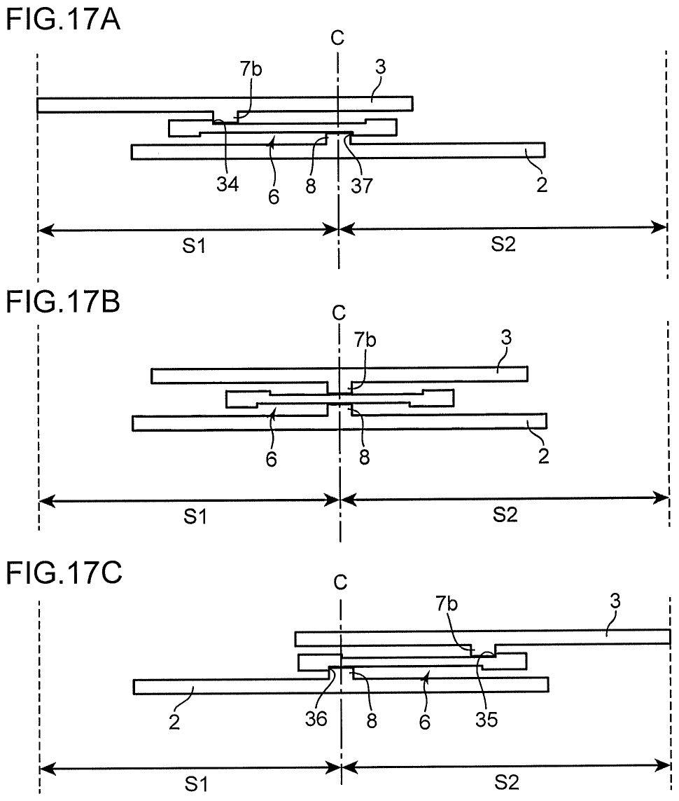

Specifically, as illustrated in FIG. 17A, when an upper rail 3 reaches a foremost position, an upper coming-off prevention part 7b approaches the front upper facing part 34 and a lower coming-off prevention part 8 approaches the rear lower facing part 37. At this time, a frontward movement amount of the upper rail 3 in a state of being at a middle position illustrated in FIG. 17B (i.e., in a state where the upper coming-off prevention part 7b is at a middle position C) is defined as S1 to be a reference. In this modification, the frontward movement amount S1 reduces as a distance between the upper facing part 34 and the lower facing part 37 is shorter.

In contrast, as illustrated in FIG. 17C, when the upper rail 3 reaches a rearmost position, the upper coming-off prevention part 7b approaches the rear upper facing part 35, and the lower coming-off prevention part 8 approaches the front lower facing part 36. At this time, a rearward movement amount of the upper rail 3 is defined as S2. In this modification, the rearward movement amount S2 increases as a distance between the upper facing part 35 and the lower facing part 36 is longer.

The modification hence enables setting of the smaller frontward movement amount S1 and the larger or smaller rearward movement amount S2. The modification is preferably applicable to a sliding device required to ensure a large front movement amount, such as a walk-in sliding device for an automobile seat.
(B) Although the lower coming-off prevention part 8 is formed by lacing a part of the lower rail 2 in the embodiment, the present invention is not limited thereto. The lower coming-off prevention part may be composed of any component intended not for prevention of coming-off of a retainer but for other purpose.
(C) The retainer 6 is arranged in the lower space 41 in the embodiment, but may be arranged in the upper space 42 or may be arranged in each of the lower space 41 and the upper space 42.
(D) Although the embodiment exemplifies the sliding device 1 including one lower coming-off prevention part 8 and one upper coming-off prevention part 7b, the present invention is not limited thereto. It is only required to provide at least one lower coming-off prevention part and at least one upper coming-off prevention part. In a case where a coming-off prevention part made of already existing material member is unsatisfactory to ensure the strength, two or more lower coming-off prevention parts or two or more upper coming-off prevention parts may be prepared. Even in this case, arrangement of the two or more lower coming-off prevention parts within a range between the pair of lower facing parts of the retainer, or arrangement of the two or more upper coming-off prevention parts within a range between the pair of upper facing parts of the retainer can exert the same operational effect as that of the embodiment.
(E) Although the upper coming-off prevention part 7b comes into contact with the stopper 9, 10 to restrict the movement of the upper rail 3 in the front-rear direction X in the embodiment, the present invention is not limited thereto. The upper rail 3 itself or a component other than the upper coming-off prevention part 7b may come into contact with the stopper 9, 10 to restrict the movement of the upper rail 3 in the front-rear direction X.
(F) Although the embodiment exemplifies application of the sliding device 1 to a walk-in sliding device that moves the seat S in the front-rear direction, the present invention is not limited thereto. Specifically, the present invention covers a sliding device that slides a seat in a width direction (or left-right direction) with a lower rail and an upper rail extending in the width direction of the seat.

### SUMMARY OF EMBODIMENT

The embodiment is summarized in the following manner.

A sliding device in the embodiment is a sliding device for supporting a seat slidably. The sliding device includes: a lower rail that is a long member to be fixedly attached to a mounting surface over which the seat is arranged; an upper rail that has a portion to be fixedly attached to the seat, is movably guided by the lower rail in a longitudinal direction of the lower rail, and defines at least one space extending in the longitudinal direction in combination with the lower rail; a plurality of balls arranged in the space between the lower rail and the upper rail and being rollable in coincidence with a movement of the upper rail; a retainer arranged in the space for retaining the balls located away from each other in the longitudinal direction; a lower coming-off prevention part located at the lower rail for preventing the retainer from coming off the space; and an upper coming-off prevention part located at the upper rail for preventing the retainer from coming off the space. The retainer includes: a first ball holding part that holds at least one of the balls arranged in the space in a rollable manner; a second ball holding part that is at a distance from the first ball holding part in the longitudinal direction in the space and holds at least one of the balls in a rollable manner; a connection part that connects the first ball holding part and the second ball holding part to each other while keeping the distance between the first and second ball holding parts; a pair of lower facing parts that face each other across the lower coming-off prevention part in the longitudinal direction; and a pair of upper facing parts that face each other across the upper coming-off prevention part in the longitudinal direction.

In the configuration, the retainer including the first ball holding part and the second ball holding part connected to each other by the connection part further includes two kind pairs of facing parts to be apart from each other and face each other in the longitudinal direction, that is, the pair of lower facing parts that face each other across the lower coming-off prevention part in the longitudinal direction and the pair of upper facing parts that face each other across the upper coming-off prevention part in the longitudinal direction. In this configuration, the lower coming-off prevention part provided at the lower rail falls within the region between the pair of lower facing parts, and the upper coming-off prevention part provided at the upper rail falls within the region between the pair of upper facing parts.

The configuration thus allows the lower coming-off prevention part and the upper coming-off prevention part each falling within an extent of the retainer in the longitudinal direction to respectively come into contact with the lower facing part and the upper facing part, resulting in achievement in preventing the retainer from coming off. This eliminates the need for a coming-off prevention member for the retainer at each of the front and rear ends of each of the lower rail and the upper rail in the longitudinal direction. Consequently, an increase in the number of processing portions and components to prevent the retainer from coming off is suppressible.

In the configuration, each of the lower coming-off prevention part and the upper coming-off prevention part falls within the extent of the retainer in the longitudinal direction thereof. Thus, the lower coming-off prevention part and the upper coming-off prevention part do not limit the distance between the first ball holding part and the second ball holding part of the retainer, that is, do not limit a pitch between balls. Hence, increasing the distance between the lower facing parts or the distance between the upper facing parts in the retainer leads to achievement in an increase in the pitch between the balls.

In the configuration, each of the lower coming-off prevention part and the upper coming-off prevention part falls within the extent of the retainer in the longitudinal direction thereof. Thus, increasing the distance between the lower facing parts or the distance between the upper facing parts in the retainer leads to an increase in the movement amount of the retainer and an increase in the movement amount of the upper rail relative to the retainer. As a result, the movement amount of the upper rail is remarkably increasable. This achieves compatibility of an increase in the pitch between the balls and an increase in the moving amount of the upper rail.

The definition “across the lower coming-off prevention part” does not mean that the pair of lower facing parts sandwich the lower coming-off prevention part therebetween, but means that the lower coming-off prevention part is located between the lower facing parts at a distance which is longer than a length of the lower coming-off prevention part therebetween in the longitudinal direction. Similarly, the definition “across the upper coming-off prevention part” does not mean that the pair of upper facing parts sandwich the upper coming-off prevention part therebetween, but means that the upper coming-off prevention part is located between the upper facing parts at a distance which is longer than a length of the upper coming-off prevention part therebetween in the longitudinal direction.

In the sliding device, the pair of lower facing parts are preferably at opposite positions of the connection part to face each other in the longitudinal direction, and the pair of upper facing parts are preferably at opposite positions of the connection part to face each other in the longitudinal direction.

In this configuration, the retainer is movable within a range in which the pair of lower facing parts do not come into contact with the lower coming-off prevention part, that is, within a range between the pair of lower facing parts. Further, the upper rail is movable within a range in which the upper coming-off prevention part does not come into contact with the pair of upper facing parts, that is, within a range between the pair of upper facing parts relative to the retainer. Consequently, the movement amount of the upper rail is remarkably increasable.

The sliding device preferably further includes a pair of stoppers located away from each other in the longitudinal direction at the lower rail for limiting a movement range of the upper rail in the longitudinal direction. The pair of lower facing parts and the pair of upper facing parts of the retainer in the retainer are preferably arranged in such a manner as to, in restriction of movement of the upper rail in the longitudinal direction by each of the stoppers, allow a gap to come into existence between corresponding one of the lower facing parts and the lower coming-off prevention part without contact therebetween in a state where the upper coming-off prevention part is at a position adjacent to corresponding one of the upper facing parts.

In this configuration, the lower facing part of the retainer does not come into contact with the lower coming-off prevention part in the state where the upper coming-off prevention part at the upper rail is at a position adjacent to the upper facing part of the retainer in the restriction of the movement of the upper rail in the longitudinal direction by the stopper. Even in rapid sliding of the upper rail, this attains suppression of deformation of the retainer without an influence of a large pulling load acting to pull the opposite ends of the retainer located in the longitudinal direction by the upper coming-off prevention part and the lower coming-off prevention part in different directions.

In the sliding device, the connection part preferably has a cross-sectional area which is smaller than a cross-sectional area of each of the first ball holding part and the second ball holding part in cross-section perpendicularly intersecting the longitudinal direction.

This configuration achieves a reduction in each of the size, the weight, and the manufacturing cost of the retainer.

As described above, the pair of lower facing parts and the pair of upper facing parts in the retainer are arranged in such a manner as to, in restriction of the movement of the upper rail in the longitudinal direction by each of the stoppers, allow a gap to come into existence between the corresponding one of the lower facing parts and the lower coming-off prevention part without contact therebetween in the state where the upper coming-off prevention part is at a position adjacent to the corresponding one of the upper facing parts. In this case, the lower coming-off prevention part and the upper coming-off prevention part do not come into contact with the retainer at the same time. This prevents the retainer from receiving a strong pulling load, and thus, attains a further smaller cross-sectional area of the connection part and achieves a further reduction in each of the size and the weight of the retainer.

In the sliding device, each of a value of two times of a length resulting from subtracting a length of the lower coming-off prevention part in the longitudinal direction from a distance between the pair of lower facing parts of the retainer, and a value of two times of a length resulting from subtracting a length of the upper coming-off prevention part in the longitudinal direction from a distance between the pair of upper facing parts is preferably set to a length correspond to a maximum movement amount of the upper rail or greater.

In this configuration, each of the value of two times of the length resulting from subtracting the length of the lower coming-off prevention part in the longitudinal direction from the distance between the pair of lower facing parts of the retainer, and the value of two times of the length resulting from subtracting the length of the upper coming-off prevention part in the longitudinal direction from the distance between the pair of upper facing parts is set to a length correspond to a maximum movement amount of the upper rail or greater. Such setting avoids a limitation to a movement amount of the upper rail attributed to the length of the connection part. This results in ensuring the maximum movement amount of the upper rail, and allowing a gap to come into existence between the upper coming-off prevention part and each of the pair of upper facing parts without contact therebetween and allows a gap to come into existence between the lower coming-off prevention part and each of the lower facing parts without contact therebetween in restriction of the movement of the upper rail in the longitudinal direction by each of the stoppers.

In the sliding device, the pair of lower facing parts are preferably at different positions from positions of the pair of upper facing parts in the longitudinal direction.

In this respect, even a configuration in which the upper coming-off prevention part or the lower coming-off prevention part has a different length in the longitudinal direction can exert the same operation effects as the configuration in which the lower and upper facing parts are at the same front and rear positions by adjusting the distance between the associated facing parts.

In the sliding device, the upper coming-off prevention part preferably constitutes a part of a lock mechanism configured to fix the upper rail at a desired position in the longitudinal direction.

This configuration prevents the retainer from coming off by using a part of the lock mechanism configured to fix the upper rail, and thus enables prevention of coming-off of the retainer without increasing the number of components and adding processing portions of the sliding device. The configuration further achieves suppression of an increase in each of the cost and the weight by avoiding the increase in the number of components of the sliding device.

In the sliding device, the lower coming-off prevention part is preferably formed by lancing a part of the lower rail.

This configuration prevents the retainer from coming off only by lancing a part of the lower rail, and thus enables prevention of coming-off of the retainer without increasing the number of components of the sliding device.

The sliding device according to the embodiment attains a decrease in the number of processing portions and components, and further achieves compatibility of an increase in the pitch between lower balls and an increase in the movement amount of the upper rail.

1. A sliding device for supporting a seat slidably, comprising:
a lower rail that is a long member to be fixedly attached to a mounting surface over which the seat is arranged;
an upper rail that has a portion to be fixedly attached to the seat, is movably guided by the lower rail in a longitudinal direction of the lower rail, and defines at least one space extending in the longitudinal direction in combination with the lower rail;
a plurality of balls arranged in the space between the lower rail and the upper rail and being rollable in coincidence with a movement of the upper rail;
a retainer arranged in the space for retaining the balls located away from each other in the longitudinal direction;
a lower coming-off prevention part provided at the lower rail for preventing the retainer from coming off the space; and
an upper coming-off prevention part provided at the upper rail for preventing the retainer from coming off the space, wherein
the retainer includes:
a first ball holding part that holds at least one of the balls arranged in the space in a rollable manner;
a second ball holding part that is at a distance from the first ball holding part in the longitudinal direction in the space and holds at least one of the balls in a rollable manner;
a connection part that connects the first ball holding part and the second ball holding part to each other while keeping the distance between the first and second ball holding parts;
a pair of lower facing parts that face each other across the lower coming-off prevention part in the longitudinal direction; and
a pair of upper facing parts that face each other across the upper coming-off prevention part in the longitudinal direction,
the lower coming-off prevention part falls within a region between the pair of lower facing parts, and
the upper coming-off prevention part falls within a region between the pair of upper facing parts.

2. The sliding device according to claim 1, wherein the pair of lower facing parts are located at opposite positions of the connection part to face each other in the longitudinal direction, and
the pair of upper facing parts are located at opposite positions of the connection part to face each other in the longitudinal direction.

3. The sliding device according to claim 1, further comprising a pair of stoppers located away from each other in the longitudinal direction at the lower rail for limiting a movement range of the upper rail in the longitudinal direction, wherein
the pair of lower facing parts and the pair of upper facing parts in the retainer are arranged in such a manner as to, in restriction of movement of the upper rail in the longitudinal direction by each of the stoppers, allow a gap to come into existence between corresponding one of the lower facing parts and the lower coming-off prevention part without contact therebetween in a state where the upper coming-off prevention part is at a position adjacent to corresponding one of the upper facing parts.

4. The sliding device according to claim 1, wherein the connection part has a cross-sectional area which is smaller than a cross-sectional area of each of the first ball holding part and the second ball holding part in cross-section perpendicularly intersecting the longitudinal direction.

5. The sliding device according to claim 1, wherein each of a value of two times of a length resulting from subtracting a length of the lower coming-off prevention part in the longitudinal direction from a distance between the pair of lower facing parts of the retainer, and a value of two times of a length resulting from subtracting a length of the upper coming-off prevention part in the longitudinal direction from a distance between the pair of upper facing parts is set to a length correspond to a maximum movement amount of the upper rail or greater.

6. The sliding device according to claim 1, wherein the pair of lower facing parts are at different positions from positions of the pair of upper facing parts in the longitudinal direction.

7. The sliding device according to claim 1, wherein the upper coming-off prevention part constitutes a part of a lock mechanism configured to fix the upper rail in a desired position in the longitudinal direction.
